(19) United States
(12) Patent Application Publication
(10) Pub. No.: US 2026/0139764 A1
(43) Pub. Date: May 21, 2026

(54) THERMAL MANAGEMENT ASSEMBLY FOR A MULTIPORT ROTARY VALVE ASSEMBLY

(71) Applicant: ILiAD IP COMPANY, LLC, Carlsbad, CA (US)

(72) Inventors: Steven Michael HERNANDEZ, Belleville, WI (US); John Lucas DRONE, Aurora, IL (US); Aaron Philip POON, Tustin, CA (US)

(73) Assignee: ILiAD IP COMPANY, LLC, Carlsbad, CA (US)

(21) Appl. No.: 19/395,737

(22) Filed: Nov. 20, 2025

Related U.S. Application Data
(60) Provisional application No. 63/723,222, filed on Nov. 21, 2024.

(51) Int. Cl. F16K 49/00; F16K 11/085; F16K 37/00

(52) U.S. Cl. CPC F16K 49/002; F16K 11/0856; F16K 37/0083

(57) ABSTRACT

An improved multiport rotary valve assembly is disclosed, designed for applications such as direct lithium extraction processes. The assembly includes a valve body comprising a housing ring, upper and lower closure discs, and a process disc, along with a thermal management assembly. The thermal management assembly integrates an insulation member, a thermal regulation assembly, and/or a startup heating assembly to address temperature differentials caused by ambient and process conditions. The insulation member minimizes external thermal influences by closely fitting, wrapping around, or covering components of the valve. The thermal regulation assembly employs temperature sensors and heating elements to maintain dimensional stability and sealing integrity. The startup heating assembly facilitates rapid preheating of the valve body to operational temperatures, enhancing initial sealing reliability. This improved design enhances operational efficiency, reduces maintenance requirements, and ensures consistent performance in fluid flow applications under varying temperature conditions.

### CROSS-REFERENCE TO RELATED APPLICATIONS

This application claims the benefit of U.S. Provisional Ser. No. 63/723,222 filed Nov. 21, 2024, and incorporates the provisional application by reference in its entirety into this document as if fully set out at this point.

### BACKGROUND OF THE INVENTION

### 1. Field of the Invention

The present disclosure pertains to thermal management systems, particularly to assemblies that address temperature variations in multiport rotary valve assemblies utilized in direct lithium extraction processes.

### 2. Description of the Related Art

In numerous industrial separation and extraction processes, precise control of fluid flow through complex valve systems is necessary to maintain process efficiency and product quality. Thermal management has a significant impact on the dimensional stability and sealing integrity of multiport rotary valves, particularly when handling fluids at varying temperatures. As the market for lithium-ion batteries and other high-performance applications continues to expand, direct lithium extraction (DLE) technologies increasingly depend on multiport valves to coordinate countercurrent adsorption and desorption cycles. These valves are required to consistently direct multiple process streams between a series of resin or adsorbent columns under changing ambient and process temperature conditions.

Multiport rotary valves are used in continuous countercurrent ion-exchange or adsorption processes to distribute feedstocks, wash solutions, and eluent streams in a coordinated sequence. Existing systems are challenged by thermal gradients that arise from variations between external ambient temperatures and the temperatures of process fluids circulating through the valve. Polymer and composite materials used in many process discs can expand, contract, or distort under temperature swings, leading to irregular seal gaps and compromised engagement. Excessive compression to counteract these effects can overstress seals and hardware, while insufficient compression can permit fluid crossover and external leakage. Manual tightening or loosening of tensioning rods in response to temperature changes is labor-intensive and prone to inconsistencies, which increases the risk of unscheduled maintenance and process interruptions.

Direct lithium extraction processes are particularly sensitive to even minor cross-contamination, as product streams often demand impurity removal levels of 99.9% or greater. Leakage or seal wear not only degrades product purity and reduces recovery yields but also raises operating costs through more frequent maintenance, replacement of wear components, and unplanned downtime. These challenges underscore the need for more reliable thermal control solutions that can actively manage temperature-induced distortions in multiport rotary valve assemblies, reduce manual intervention, and maintain tight sealing performance throughout startup, steady-state operation, and temperature fluctuations.

### SUMMARY OF THE INVENTION

The multiport rotary valve assembly integrates a thermal management assembly to address temperature differentials caused by ambient and process conditions. By incorporating a housing ring, upper and lower closure discs, and a process disc within the valve body, the assembly ensures structural integrity and dimensional stability under varying thermal environments. The thermal management assembly, comprising an insulation member, a thermal regulation assembly, and/or a startup heating assembly, actively mitigates temperature-induced distortions in the valve body components.

The insulation member minimizes external thermal influences by closely fitting against, wrapping around, or otherwise covering components of the valve body, such as the housing ring, closure discs, and deflection plates. This arrangement reduces the risk of irregular seal gaps and fluid leakage, which are common in conventional systems exposed to thermal gradients. The thermal regulation assembly further enhances operational reliability by employing temperature sensors and heating elements to monitor and maintain the valve body's temperature in real-time, ensuring consistent sealing performance and preventing cross-contamination of process fluids. Additionally, the startup heating assembly facilitates rapid preheating of the valve body to operational temperatures, reducing startup complexity and improving the probability of achieving proper initial sealing.

This configuration offers a practical solution to the challenges presented by temperature variations in direct lithium extraction processes, where maintaining high product purity and minimizing leakage are key considerations. The assembly reduces manual intervention, enhances sealing reliability, and ensures efficient fluid distribution across multiple process streams, thereby improving overall process efficiency and reducing maintenance requirements.

In general, in a first aspect, the invention relates to a multiport rotary valve assembly having a valve body. The valve body has a housing ring, an upper closure disc, a lower closure disc, and a process disc. The upper closure disc and the lower closure disc are attached to opposing ends of the housing ring, and the process disc is seated within the housing ring. The valve assembly also has a thermal management assembly with an insulation member, a thermal regulation assembly, and/or a startup heating assembly. The thermal management assembly is configured to mitigate temperature differentials on the valve body due to ambient and process conditions.

In an embodiment, the insulation member is adapted to closely fit against, wrap around, or otherwise cover an upper deflection plate, the upper closure disc, the housing ring, the lower closure disc, and/or a lower deflection plate of the valve body.

In an embodiment, the insulation member is rigid, semi-rigid, or flexible.

In an embodiment, the insulation member is of a unitary construction or constructed from multiple insulation segments.

In an embodiment, the insulation member has one or more fasteners configured to secure the insulation member around all or a portion of the valve body.

In an embodiment, the insulation member is a removable flexible thermal insulating jacket, sheet, sleeve, or other insulative covering that generally conforms to the shape of the valve body.

In an embodiment, the insulation member is constructed from one or more natural or synthetic rubbers or other polymer-based materials.

In an embodiment, the insulation member is constructed from chloroprene, neoprene, isobutylene, isoprene, or a combination thereof.

In an embodiment, the insulation member is constructed from elastomeric foam, closed-cell foam, open-cell foam (e.g., aerogels), wool, cellulose, silica, fiberglass, bubble wrap, polyurethane, or a combination thereof.

In an embodiment, the thermal regulation assembly has one or more temperature probes or sensors and heating elements.

In an embodiment, the sensors and/or the heating elements are positioned beneath or within the insulation member or near or against the valve body.

In an embodiment, the temperature probes or sensors are negative temperature coefficient (NTC) thermistors, resistance temperature detectors (RTDs), thermocouples, semiconductor-based integrated (IC) sensors, or a combination thereof.

In an embodiment, the heating element is electric, fluid (e.g., liquid or gas), or a combination thereof, with the fluid being heated and circulated through a warming jacket or tubes wrapped about or covering the valve body.

In an embodiment, the fluid is water, synthetic thermal fluids, mineral oil, hot/thermal oil, glycol (e.g., ethylene glycol or propylene glycol mixture), water/glycol mixture, silicon-based fluids, nanofluids, air, steam, vapor, or a combination or mixture thereof to allow for the transfer of energy from the heated fluid to the components of the valve body.

In an embodiment, the thermal regulation assembly has a warming fluid reservoir with a heat source for heating the fluid to a desired temperature.

In an embodiment, the heated fluid is recycled from a fluid distribution process.

In an embodiment, the thermal regulation assembly is configured to monitor the temperature of the valve body and, in response, pass heated fluid or electric current through the heating element as needed to maintain a desired temperature at a surface of the valve body.

In an embodiment, the startup heating assembly has one or more warming loop channels within (e.g., either cut or installed internally) the upper closure disc, the housing ring, the process disc, and/or the lower closure disc to distribute heated fluid therethrough.

In an embodiment, the startup heating assembly is configured to monitor the temperature of the valve body and, in response, regulate the temperature of the heated fluid at the source and/or pass more or less heated fluid through the warming loop channels within the housing ring and/or the process disc as needed during startup of the valve assembly.

In an embodiment, the startup heating assembly has one or more temperature probes or sensors on the valve body and/or within the insulation member.

In an embodiment, the temperature probes or sensors are negative temperature coefficient (NTC) thermistors, resistance temperature detectors (RTDs), thermocouples, semiconductor-based integrated (IC) sensors, or a combination thereof.

In an embodiment, the startup heating assembly has a warming fluid reservoir having a heat source for heating the fluid to a desired temperature.

In an embodiment, a controller is in communication with the thermal regulation assembly, the startup heating assembly, or both.

In an embodiment, the controller comprises one or more PID temperature controllers, one or more PID flow controllers, one or more PID pressure controllers, or a combination thereof.

In general, in a second aspect, the invention relates to a process having the steps of:
engaging a multiport rotary valve assembly with a thermal management assembly, wherein the thermal management assembly comprises an insulation member, a thermal regulation assembly, and/or a startup heating assembly;
heating the valve assembly to an operational temperature; and
monitoring a temperature of the valve body using the thermal management assembly.

In an embodiment, the process also includes the step of wrapping and/or covering the valve body with the insulation member.

In an embodiment, the process also includes the step of controlling the temperature of the valve body using the thermal management assembly.

In an embodiment, the process also includes the step of pumping warming fluid or other heating media to the thermal management assembly and/or regulating a temperature of the warming fluid as needed to maintain a desired temperature at a surface of the valve body.

In an embodiment, the process also includes the step of pumping the warming fluid or other heating media to a heating element of the thermal regulation assembly, pumping the warming fluid (media) to a warming loop channel of the startup heating assembly, regulating the temperature of the warming fluid (media) of the startup heating assembly, or a combination thereof.

In an embodiment, the process also includes the step of pumping the warming fluid or heating media to a warming fluid reservoir of the thermal regulation assembly having a heat source for heating the fluid to a desired temperature, pumping the warming fluid to a warming loop channel, regulating the temperature of the warming fluid of the startup heating assembly, or a combination thereof.

### BRIEF DESCRIPTION OF DRAWINGS

The above and other objects and advantages of this invention may be more clearly seen when viewed in conjunction with the accompanying drawing wherein:

FIG. 1 is an elevation view of an example of a multiport rotary valve assembly comprising a thermal management assembly (shown partially cutaway for clarity) constructed in accordance with an exemplary embodiment.

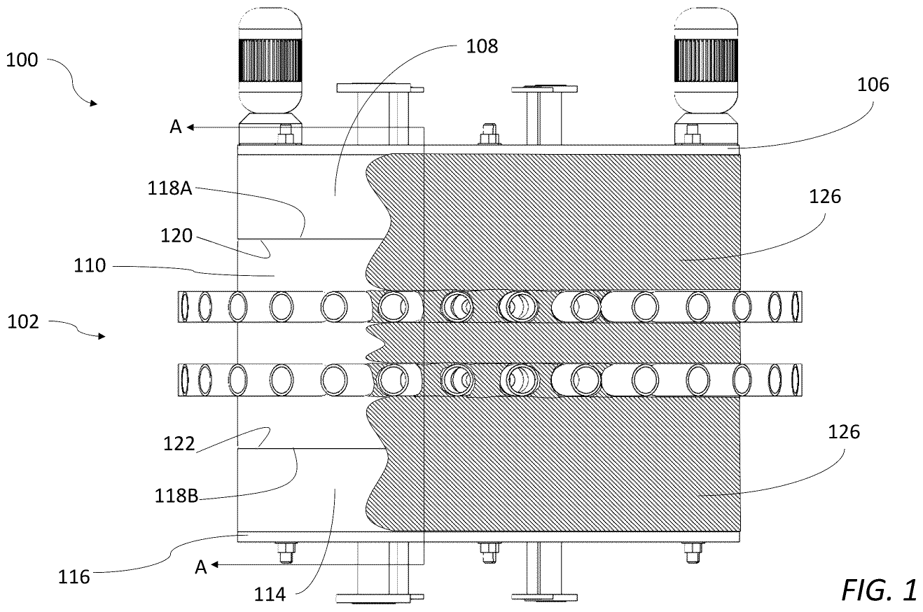

FIG. 2 is a perspective view of the valve assembly shown in FIG. 1.

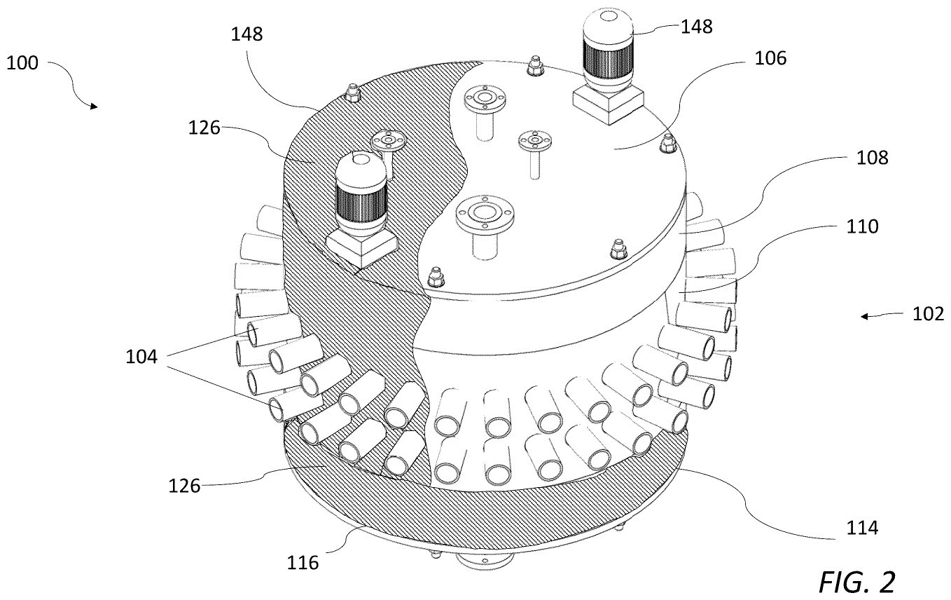

FIG. 3 is a cross-sectional view along lines A-A of FIG. 1.

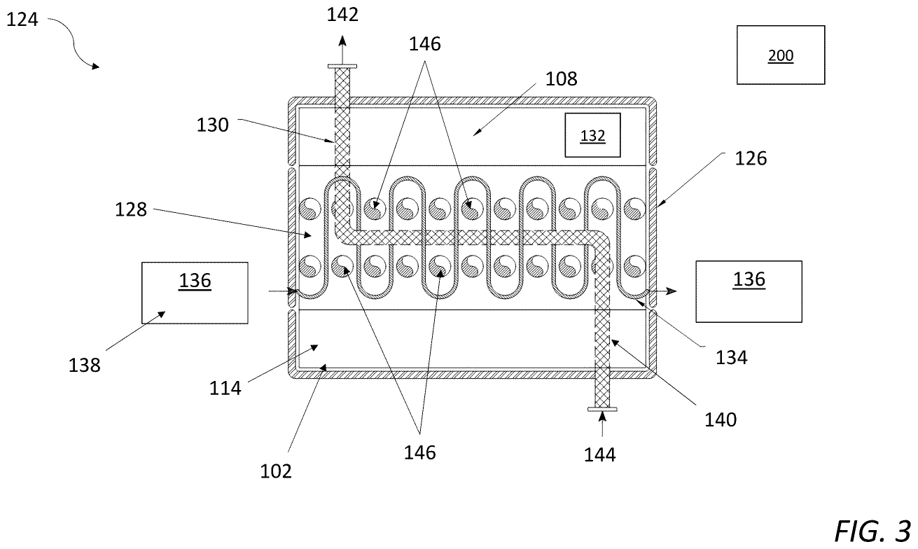

### DETAILED DESCRIPTION

The present detailed description provides illustrative embodiments of the described technology, which pertains to thermal management systems for multiport rotary valve assemblies. These assemblies are particularly suited for applications requiring precise control of fluid flow under varying temperature conditions, such as direct lithium extraction processes. The described technology addresses challenges associated with temperature-induced distortions in valve components, ensuring reliable sealing performance and operational efficiency. While specific embodiments and configurations are described herein, it is understood that the described technology is not limited to these examples and may encompass other variations, modifications, and applications within the scope of the claims.

Certain well-known elements, methods, and techniques commonly understood by those skilled in the art may not be described in detail to avoid redundancy and maintain clarity. The examples provided are intended to illustrate the principles of the described subject matter and are not to be construed as limiting. Various substitutions, rearrangements, and modifications of the described embodiments may be made without departing from the spirit and scope of the subject matter as defined by the appended claims.

The present disclosure addresses thermal management challenges in multiport rotary valve assemblies, particularly those used in direct lithium extraction processes. The invention disclosed herein improves upon prior approaches by introducing a thermal management assembly specifically designed to mitigate the effects of temperature differentials on multiport rotary valve assemblies. This assembly integrates an insulation member, a thermal regulation assembly, and/or a startup heating assembly to actively manage temperature variations and ensure consistent sealing performance. The insulation member minimizes external thermal influences by closely fitting, wrapping around, or otherwise covering significant valve components, such as the housing ring, closure discs, and deflection plates. Constructed from advanced materials, including synthetic rubbers, elastomeric foams, and aerogels, the insulation member provides robust thermal protection while accommodating various operational environments. The thermal regulation assembly incorporates temperature sensors and heating elements to monitor and maintain the valve body's temperature in real-time, ensuring dimensional stability and optimal sealing. Additionally, the startup heating assembly facilitates rapid preheating of the valve body to operational temperatures, reducing startup complexity and improving initial sealing reliability.

By combining these elements, the disclosed invention addresses the shortcomings of conventional systems, offering a more reliable, automated, and efficient solution for thermal management in multiport rotary valve assemblies. The integration of real-time temperature monitoring, advanced insulation materials, and controlled heating mechanisms ensures consistent performance across varying ambient and process conditions, significantly reducing maintenance requirements and enhancing operational efficiency in DLE and other fluid flow applications.

Referring to the figures of the drawings, wherein like numerals of reference designate like elements throughout the several views, a general arrangement for the improved multiport rotary valve assembly 100 is depicted. The improved multiport rotary valve assembly 100 includes a thermal management assembly 124 to mitigate the effects of temperature differentials due to ambient and process conditions. The thermal management assembly 124 can include an insulation member 126, a thermal regulation assembly 128, and/or a startup heating assembly 130 to reduce the startup complexity and increase the rate of successful sealing.

For purposes of illustration rather than limitation, the multiport rotary valve assembly 100 is exemplified in connection with process fluid distribution and transport during continuous countercurrent adsorption and desorption (“CCAD”) processes, such as selective lithium and mineral recovery from natural and synthetic feedstocks. However, the multiport rotary valve assembly 100 should not be so limited, as the invention can be utilized in other fluid flow applications. The brine or feedstock solution can be from any lithium brine deposit or resource, such as continental brines, salar brines, geothermal brines, oil field feedstock solutions, brine evaporation ponds, leachate solutions from ore, hard rock, clay, or spodumene lithium mining and beneficiation, solutions from battery recycling processes, mother liquors, pregnant leach or liquor solutions (PLS), or any other lithium-containing brine or solution. The feedstock solution may be subject to a variety of preliminary treatment steps, including the removal of solids and certain problem metals or metals of commerce (e.g., iron, manganese, zinc, silicon, etc.), and brine from hard rock lithium mining activity, clay, spodumene, battery metal recycling, and other PLS feedstock solutions are generally leached with sulfuric acid (H₂SO₄).

Varying process fluid temperatures and ambient temperature swings, which can be extreme in some lithium-rich brine-bearing resources, can lead to temperature differentials within the multiport rotary valve assembly 100. These temperature differentials can cause localized flexure and distortions within the valve assembly 100, resulting in irregular gapping on the sealing surfaces, and this diminished sealing capability leads to internal (crossflow) and external leakage, reducing the overall efficiency of the extraction process. Additionally, initial sealing requires the valve assembly 100 to be at operating temperature (e.g., between about 40° C. and about 80° C.) to achieve proper and repeatable sealing, which is generally achieved by running heated process fluids through the valve assembly 100 for several hours.

As exemplified in the figures, the valve assembly 100 includes a valve body 102 that is fluidly connected via distribution ports 104 to a plurality of external vessels (e.g., ion exchange or adsorption and desorption columns or beds) (not shown) for process fluid distribution and transport. The adsorbent beds or columns are arranged into process zones, each containing an adsorbent or resin (e.g., a lithium- or mineral-selective adsorbent or ion-exchange resin). Distribution of process fluids through the multiport rotary valve assembly 100 is conducted via internal porting of distribution channels 146 within the valve body 102 before flowing to the columns or vessels from the distribution ports 104 in predetermined process sequences.

The valve body 102 of the multiport rotary valve assembly 100 includes an upper deflection plate 106, an upper closure disc 108, a body or housing ring 110, a process disc 112, a lower closure disc 114, and a lower deflection plate 116. The housing ring 110 has opposing generally planar axial or open ends 118A/118B and is configured to surround the perimeter of the process disc 112. The housing ring 110, along with the upper and lower closure discs 108 and 114, defines an internal valve chamber. The process disc 112 is seated within this internal valve chamber and is rotatable about a central axis. The process disc 112 may be made of polymeric materials that are subject to temperature distortion exacerbated by the differential between ambient external temperatures and internal process temperatures. The process disc 112 can be a unitary construction or be constructed from multiple process discs and materials stacked coaxially, sealed, and connected within the housing ring 110. The upper closure disc 108, the process disc 112, and the lower closure disc 114 are coaxially aligned and axially spaced along the central axis.

The housing ring 110 defines end openings 118A/118B with the upper closure disc 108 and the lower closure disc 114 secured thereto, respectively. The upper closure disc 108 and the lower closure disc 114 can be sealed with respect to the housing ring 110 by annular seals or seal assemblies. The seal assemblies can be carried within circular seal grooves defined in the end openings 118A/118B of the housing ring 110, in the periphery of a lower sealing surface 120 of the upper closure disc 108, and or in the periphery of an upper sealing surface 122 of the lower closure disc 114. The annular seals or seal assemblies 124 may be elastomer or polymer seals that provide sealing within a normal operating temperature range.

The upper deflection plate 106, the upper closure disc 108, the lower closure disc 114, the lower deflection plate 116, and/or the housing ring 110 can be flanged, threaded, or otherwise configured to match that of the mating connection; for example, a plurality of axially aligned fastener openings can be provided to receive bolts, threaded studs, tensioning rods, or the like to secure the upper deflection plate 106, the upper closure disc 108, the lower closure disc 114, and the lower deflection plate 116 in sealing engagement to the respective end openings 118A/118B of the housing ring 110, and thereby compressing the process disc 112 within the housing ring 110. The upper deflection plate 106 and the lower deflection plate 116 distribute the compressive load from the tensioning rods to the upper and lower closure discs 108/114 and the housing ring 110, thereby sealing the valve body 102 and constraining the process disc 112.

The improved multiport rotary valve assembly 100 can include a thermal management assembly 124 to mitigate the effects of temperature differentials due to ambient and process conditions, reduce startup complexity, and enhance sealing of the valve body 102. The thermal management assembly 124 can include one or more insulation members 126, and other materials (e.g., protective) as needed for the particular application, adapted to closely fit against, wrap around, or otherwise cover the upper deflection plate 106, the upper closure disc 108, the housing ring 110, the lower closure disc 114, and/or the lower deflection plate 116 of the valve body 102. The insulation member 126 can be rigid or semi-rigid, such as with two or more mating sections, or flexible, such as a removable, flexible thermal insulating jacket, sheet, sleeve, or other insulative covering that generally conforms to the shape of the valve body 102. The insulation member 126 can be adapted to fit around the distribution ports 104 and other pipes, hoses, and fixtures, thereby preventing or minimizing the effects of outside environmental influences, such as temperature fluctuations, moisture, and debris. The insulation member 126 can be a unitary construction or be constructed from multiple segments of insulation, and in the latter case, can include one or more commercially available fasteners (e.g., adhesive, hook and loop fasteners, straps), enabling a user to secure the insulation member 126 around all or a portion of the valve body 102.

The insulation member 126 can be removable and/or reusable, and may have multiple layers of different materials, depending on the operating environment. It can also provide differing levels of insulation based on costs and desired thermal transfer characteristics. Additionally, the environment in which the valve assembly 100 is to be used and the type of insulative layer may determine the number and type of protective layers required. The insulation member 126 can be constructed from one or more natural or synthetic rubbers or other polymer-based materials, including chloroprene, neoprene, isobutylene, and isoprene. Alternatively, the insulation member 126 can be constructed from elastomeric foam, closed-cell foam, open-cell foam (e.g., aerogels), wool, cellulose, silica, fiberglass, bubble wrap, polyurethane, or a combination thereof.

In addition to the insulation member 126, the thermal management assembly 124 can include the thermal regulation assembly 128, which has one or more temperature probes or sensors 132 and heating elements 134 positioned in a desired location beneath or within the insulation member 126. The temperature probes or sensors 132 and the heating elements 134 can also be positioned near or against the valve body 102 (e.g., if the thermal management assembly 124 does not include the insulation member 126). The temperature probes or sensors 132 can be negative temperature coefficient (NTC) thermistors, resistance temperature detectors (RTDs), thermocouples, semiconductor-based integrated (IC) sensors, or a combination thereof. The heating element 134 may be electric, fluid, or a combination thereof, wherein the fluid is heated and circulated through a warming jacket or tubes wrapped around the valve body 102, either under or within the insulation member 126. The fluid can be any suitable liquid or gas heating media, such as water, synthetic thermal fluids, mineral oil, hot/thermal oil, glycol (e.g., ethylene glycol or propylene glycol mixture), water/glycol mixture, silicon-based fluids, nanofluids, air, steam, vapor, or a combination or mixture thereof to allow for the transfer of energy from the heating fluid media to the components of the valve body.

The temperature, flow rate, pressure, and other process variables of the thermal regulation assembly 128 can be controlled by one or more controllers 200 (e.g., one or more PID temperature controllers, one or more PID flow controllers, one or more PID pressure controllers, or a combination thereof). The controllers 200 are configured to control temperature, flow, and/or pressure of the recirculating heating fluid or other heating medium and can be further configure for a combination of temperature and flow control, temperature and pressure control, pressure and flow control, or all of the above. The thermal regulation assembly 128 can include a warming fluid reservoir 136 with a direct immersion heating element, a heat exchanger, or another heat source 138 for heating the fluid to a desired temperature before it is pumped to the heating element 134. Alternatively, to minimize energy demand and consumption, the heated fluid for heating element 134 can be recycled and supplied from the fluid distribution process, such as from the CCAD or lithium purification process(s). The thermal regulation assembly 128 is configured to monitor the temperature of the valve body 102 in real-time and, in response, pass heated fluid (e.g., heated liquid, steam, vapor, or other heated gas) or electric current through the heating element 134 as needed to maintain a constant temperature at the surface of the valve body 102.

Internal porting of the distribution channels 146 within the process disc 112 distributes the process fluid from distribution ports 104 in the housing ring 110 to and from the columns or vessels arranged into process zones in predetermined process sequences. Upon return from the columns or vessels, the process fluid is either further distributed through additional process zones or fluidly sent from the effluent passageways in the upper closure disc 108 and the lower closure disc 114 to an external tank or vessel (not shown).

Based on the material construction of the process disc 112, the multiport rotary valve assembly 100 is subject to fluid leakage if the spaces between the housing ring 110 and/or the upper and lower closure discs 108/114 and the process disc 112 are not properly sealed, especially during DLE applications. Furthermore, the distribution channels 146, influent passageways, and effluent passageways may carry several different process fluids, and the proximity of these fluids within the valve body 102 and process disc 112 presents potential leak paths, thus requiring sealing engagement.

Accordingly, the thermal management assembly 124 can also include the startup heating assembly 130, which has one or more warming loop channels 140 within the upper closure disc 108, the housing ring 110, the process disc 112, and/or the lower closure disc 114 to distribute heated fluid therethrough. For example, the warming loop channels 140 can be cut or secondarily installed within the closure disc 108, the housing ring 110, the process disc 112, and/or the lower closure disc 114 of the valve body 102. The startup heating assembly 130 is configured to monitor the temperature of the valve body 102 in real-time and, in response, regulate the temperature of the heated fluid and/or pass more or less heated fluid through a warmup fluid inlet 144 to the warming loop channels 140 within the upper closure disc 108, the housing ring 110, the process disc 112, and/or the lower closure disc 114 as needed during startup of the valve assembly 100. The heated fluid is passed from the warming loop channels 140 through a warming fluid outlet 142.

If the thermal regulation assembly 128 is utilized with the valve assembly 100, the startup heating assembly 130 can be in communication with the temperature probes or sensors 132 and the controller 200 to monitor and maintain the temperature of the valve body 102 and/or regulate the warming fluid temperature during startup. In addition, the heated fluid can be pumped from the warming fluid reservoir 136 or preheated brine can be recycled and supplied from the fluid distribution process. However, if the thermal regulation assembly 128 is not utilized with the valve assembly 100, the startup heating assembly 130 can include one or more temperature probes or sensors, warming fluid reservoirs and pumps, heating elements, fluid sources, controllers, or a combination thereof. The temperature probes or sensors can be positioned in a desired location beneath or within the insulation member 126, or if the thermal management assembly 124 does not include the insulation member 126, the temperature probes or sensors can be positioned near or against the valve body 102.

The real-time data, including valve body and heated fluid temperature data, can be stored using the computer processor/controller 200 and displayed on a display mounted to the valve assembly 100. In addition, the thermal regulation assembly 128 and/or the startup heating assembly 130 can include a power switch and a plurality of indicator lights to visually display power status, system alarm status, temperatures, and other operational statuses.

In various embodiments, the controller 200 is employed to control process conditions during startup and operation. The controller 200 will typically include one or more memory devices and one or more processors. A processor may include a PID controller, a CPU, or a computer, as well as analog and/or digital input/output connections, controller boards, and other components.

The controller 200 may control all of the activities of the multiport rotary valve assembly 100, the thermal management assembly 124, or both. The system controller 200 executes system control software, which includes sets of instructions for controlling the timing, temperatures, flow rates, and flow paths of the warming fluids, as well as other process parameters. Other computer programs stored on memory devices associated with the controller 200 may be employed in some embodiments.

Typically, a user interface is associated with the controller 200. The user interface may include a display screen, graphical software displays of the apparatus and/or process conditions, and user input devices such as pointing devices, keyboards, touchscreens, microphones, and other similar devices.

System control logic may be configured in any suitable way. In general, logic can be designed or configured in both hardware and software. The instructions for controlling the thermal management circuitry may be hard-coded or provided as software. The instructions may be provided by “programming.” Such programming is understood to include logic of any form, including hard-coded logic in digital signal processors, application-specific integrated circuits, and other devices that have specific algorithms implemented as hardware. Programming is also understood to include software or firmware instructions that can be executed on a general-purpose processor. System control software may be coded in any suitable computer-readable programming language.

The computer program code for controlling the warming temperature, fluid flow, and other processes in a process sequence can be written in any conventional computer-readable programming language, such as assembly language, C, C++, Pascal, Fortran, or others. The processor executes compiled object code or script to perform the tasks identified in the program. Additionally, as indicated, the program code may be hard-coded.

The controller parameters relate to process conditions, such as process fluid composition, pH, concentrations, process fluid and warming fluid flow rates, temperatures, pressures, and other process parameters and conditions. These parameters are provided to the user and may be entered utilizing the user interface.

The system software may be designed or configured in many different ways. For example, various valve and thermal management component subroutines or control objects may be written to control the operation of the valve and thermal management components necessary to carry out the startup and operational processes in accordance with the disclosed embodiments. Examples of programs or sections of programs for this purpose include process disc and process fluid control code, warming fluid control code, and heater control code.

In some implementations, a controller 200 is part of a system, which may be part of the above-described examples. These systems may be integrated with electronics for controlling their operation before, during, and after the processing of a process, such as warming or other fluid handling. The electronics may be referred to as the “controller,” which may control various components or subparts of the system or systems. The controller 200, depending on the processing requirements and/or the type of system, may be programmed to control any of the processes disclosed herein, including the delivery of warming fluids, temperature settings (e.g., heating and/or cooling), flow path settings, fluid flow rate settings, and other operational components connected to or interfaced with a specific system.

Broadly speaking, the controller can be defined as electronics comprising various integrated circuits, logic, memory, and/or software that receive instructions, issue instructions, control operations, enable cleaning operations, and facilitate endpoint measurements, among other functions. The integrated circuits may include chips in the form of firmware that store program instructions, digital signal processors (DSPs), application-specific integrated circuits (ASICs), and/or one or more microprocessors or microcontrollers that execute program instructions (e.g., software). Program instructions are the instructions communicated to the controller in the form of various individual settings (or program files), which define operational parameters for carrying out a particular process.

The controller 200, in some implementations, may be part of or coupled to a computer that is integrated with, coupled to, or networked to the system, or a combination thereof. For example, the controller 200 may be in the “cloud” or all or a part of a host computer system, which can allow for remote access to the lithium or mineral processing. The computer may enable remote access to the system to monitor the current progress of startup and processing operations, examine a history of past startup and processing operations, examine trends or performance metrics from a plurality of startup and processing operations, change parameters of current processing, set processing steps to follow a current processing, or start a new process. Thus, as described above, the controller may be distributed, comprising one or more discrete controllers that are networked together and work towards a common purpose, such as the processes and controls described herein.

As used herein, the term “fluidly connected” means connected by a fluid transfer conduit or any other method that permits fluid transfer, with or without intervening elements, such as, without limitation, containers, filters, devices, pumps, valves, etc. A non-limiting example, two tanks or vessels may be “fluidly connected” if they are connected to each other through a pipe or tube, even if a pump, manifold, valve, or other device is placed inline between the vessels. Two elements are considered to be “fluidly connected” even though there is no pipe or tubing making the connection if the first element leaks or otherwise drains, overflows, siphons, or transfers into the second element, though there may be no actual physical connection between the two elements in the form of a pipe or tube. As used herein, the term “in fluid communication with” means that a fluid-carrying or fluid-transporting member (e.g., vessel, tank, pump, pipe, tubing, disc, valve, channel, port, etc.) is coupled to another fluid-carrying or fluid-transporting member so as to permit the fluid to flow, leak, or otherwise migrate from one member to the other. In reference to a process or circuit, the term “downstream” means later in the direction of general process and/or fluid flow, and “upstream” means earlier in the direction of general process and/or flow.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the method to be operated in a particular orientation. Terms such as “connected,” “coupled,” “connecting,” “attached,” “attaching,” “join,” and “joining” are used interchangeably and refer to one structure or surface being secured to another structure or surface or integrally fabricated in one piece.

Although an overview of the disclosed subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A multiport rotary valve assembly, comprising:
a valve body comprising a housing ring, an upper closure disc, a lower closure disc, and a process disc; the upper closure disc and the lower closure disc attached to opposing ends of the housing ring; the process disc seated within the housing ring; and
a thermal management assembly comprising an insulation member, a thermal regulation assembly, and/or a startup heating assembly; the thermal management assembly configured to mitigate temperature differentials on the valve body due to ambient and process conditions.

2. The assembly of claim 1, wherein the insulation member is adapted to closely fit against, wrap around, and/or cover an upper deflection plate, the upper closure disc, the housing ring, the lower closure disc, and/or a lower deflection plate of the valve body.

3. The assembly of claim 1, wherein the insulation member is rigid, semi-rigid, or flexible.

4. The assembly of claim 3, wherein the insulation member is of a unitary construction or constructed from multiple insulation segments.

5. The assembly of claim 4, wherein the insulation member comprises one or more fasteners configured to secure the insulation member to or around all or a portion of the valve body.

6. The assembly of claim 4, wherein the insulation member comprises a removable flexible thermal insulating jacket, sheet, sleeve, or other insulative covering that generally conforms to the shape of the valve body.

7. The assembly of claim 4, wherein the insulation member is constructed from one or more natural or synthetic rubbers or other polymer-based materials.

8. The assembly of claim 7, wherein the insulation member is constructed from chloroprene, neoprene, isobutylene, isoprene, or a combination thereof.

9. The assembly of claim 4, wherein the insulation member is constructed from elastomeric foam, closed-cell foam, open-cell foam, wool, cellulose, silica, fiberglass, bubble wrap, polyurethane, or a combination thereof.

10. The assembly of claim 9, wherein the open-cell foam comprises aerogels.

11. The assembly of claim 1, wherein the thermal regulation assembly comprises one or more temperature probes or sensors and heating elements.

12. The assembly of claim 11, wherein the sensors and/or the heating elements are positioned beneath or within the insulation member or near or against the valve body.

13. The assembly of claim 11, wherein the temperature probes or sensors comprise negative temperature coefficient (NTC) thermistors, resistance temperature detectors (RTDs), thermocouples, semiconductor-based integrated (IC) sensors, or a combination thereof.

14. The assembly of claim 11, wherein the heating element comprises electric, fluid, or a combination thereof.

15. The assembly of claim 14, wherein the fluid comprises a liquid or a gas heating media, and wherein the fluid is heated and circulated through a warming jacket or tubes wrapped about or covering the valve body.

16. The assembly of claim 15, wherein the fluid comprises water, synthetic thermal fluids, mineral oil, hot/thermal oil, glycol (e.g., ethylene glycol or propylene glycol mixture), water/glycol mixture, silicon-based fluids, nanofluids, air, steam, vapor, or a combination or mixture thereof to allow for the transfer of energy from the heated fluid to the components of the valve body.

17. The assembly of claim 14, wherein the thermal regulation assembly comprises a warming fluid reservoir having a heat source for heating the fluid to a desired temperature.

18. The assembly of claim 14, wherein the fluid is recycled from a fluid distribution process.

19. The assembly of claim 14, wherein the thermal regulation assembly is configured to monitor the temperature of the valve body and, in response, pass heated fluid or electric current through the heating element as needed to maintain a desired temperature at a surface of the valve body.

20. The assembly of claim 1, wherein the startup heating assembly comprises one or more warming loop channels within the upper closure disc, the housing ring, the process disc, and/or the lower closure disc of the valve body to distribute heated fluid therethrough.

21. The assembly of claim 20, wherein the warming loop channels are cut or installed internally within the upper closure disc, the housing ring, the process disc, and/or the lower closure disc of the valve body.

22. The assembly of claim 20, wherein the startup heating assembly is configured to monitor the temperature of the valve body and, in response, regulate the temperature of the heated fluid and/or pass more or less heated fluid through the warming loop channels within the upper closure disc, the housing ring, the process disc, and/or the lower closure disc of the valve body as needed during startup of the valve assembly.

23. The assembly of claim 20, wherein the startup heating assembly comprises one or more temperature probes or sensors on the valve body and/or within the insulation member.

24. The assembly of claim 23, wherein the temperature probes or sensors comprise negative temperature coefficient (NTC) thermistors, resistance temperature detectors (RTDs), thermocouples, semiconductor-based integrated (IC) sensors, or a combination thereof.

25. The assembly of claim 20, wherein the startup heating assembly comprises a warming fluid reservoir having a heat source for heating the fluid to a desired temperature.

26. The assembly of claim 1 further comprising a controller in communication with the thermal regulation assembly, the startup heating assembly, or both.

27. The assembly of claim 26, wherein the controller comprises a PID temperature controller, a PID flow controller, a PID pressure controller, or a combination thereof.

28. A process, comprising the steps of:
engaging a multiport rotary valve assembly with a thermal management assembly, wherein the thermal management assembly comprises an insulation member, a thermal regulation assembly, and/or a startup heating assembly;
heating the valve assembly to an operational temperature; and
monitoring a temperature of the valve body using the thermal management assembly.

29. The process of claim 28 further comprising the step of wrapping and/or covering the valve body with the insulation member.

30. The process of claim 28 further comprising the step of controlling the temperature of the valve body using the thermal management assembly.

31. The process of claim 28 further comprising the step of pumping warming fluid or other heating media to the thermal management assembly and/or regulating a temperature of the warming fluid or heating media as needed to maintain a desired temperature at a surface of the valve body.

32. The process of claim 31 further comprising the step of pumping the warming fluid or heating media to a heating element of the thermal regulation assembly, pumping the warming fluid to a warming loop channel, regulating the temperature of the warming fluid of the startup heating assembly, or a combination thereof.

33. The process of claim 31 further comprising the step of pumping the warming fluid or heating media to a warming fluid reservoir of the thermal regulation assembly having a heat source for heating the fluid to a desired temperature, pumping the warming fluid to a warming loop channel, regulating the temperature of the warming fluid of the startup heating assembly, or a combination thereof.
